(19) United States
(12) Patent Application Publication
(10) Pub. No.: US 2010/0321500 A1
(43) Pub. Date: Dec. 23, 2010

(54) SYSTEM AND METHOD FOR ADDRESSING VIDEO SURVEILLANCE FIELDS OF VIEW LIMITATIONS

(75) Inventors: Alan Cornett, Andover, MN (US); Robert Charles Becker, Eden Prairie, MN (US); Andrew H. Johnson, New Brighton, MN (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/487,365

(22) Filed: Jun. 18, 2009

(51) Int. Cl. H04N 7/18; G06K 9/00

(52) U.S. Cl. 348/159; 382/106; 348/E07.085

(57) ABSTRACT

A system and method for addressing video surveillance fields of view limitations. The system includes a first video camera that located at a first vantage point and a second video camera that is located at a second vantage point. A first lidar is located at the first vantage point and a second lidar is located at the second vantage point. A global positioning system is used to determine the global position of the first and second cameras and the first and second lidars. A processor receives data from the first camera, the second camera, the first lidar, the second lidar and the global positioning system. The processor creates a synthetic video image from any vantage point that is located between the first and second vantage points using the data from the first and second video cameras, the first and second lidars and the global positioning system.

### BACKGROUND

One of the drawbacks with using video surveillance to monitor a location is that it can be difficult to determine where there are coverage gaps in the surveillance. This difficulty is exacerbated when reconciling surveillance coverage from multiple viewpoints (i.e., when several video cameras are used to cover an area from multiple locations).

The video cameras in a typical security system are usually placed such that all of the scenes which are viewed by the cameras overlap to some extent. However, there are often areas where one or more obstacles block a portion of the field of view of one camera and the remaining cameras are unable to provide adequate surveillance of the blocked area. These gaps in the video surveillance may not be readily apparent when camera data is viewed by security personnel.

One method that is used to minimize the size and number of blocked video coverage areas is to place surveillance cameras at optimal locations such that the effect of obstacles is minimized. The placement of cameras in these desired positions can often be problematic because there may be no infrastructure or supporting structures that exist at these locations making it difficult and/or expensive to adequately mount the video cameras. In addition, even if special arrangements are made to place cameras at these locations, there are typically unforeseen areas of blocked coverage.

Another of the current methods that is used to minimize the size and number of blocked video coverage areas is to place multiple cameras in an area and use rotating field of views for each of the cameras. One of the shortcomings associated with using rotating field of views for each of the cameras is that events in the field of view of the camera can transpire when the camera is not pointing where the events occur. Security personal monitoring multiple screens, and particularly screens with rotating fields of view, frequently fail to detect activity on those screens. In addition, even when rotating field of views are used for each of the cameras, there are typically unforeseen areas of blocked coverage.

### BRIEF DESCRIPTION OF THE DRAWINGS

FIG. 1 is a flowchart illustrating a method for addressing video surveillance field of view limitations according to an example embodiment.

FIG. 2 illustrates a system for addressing video surveillance field of view limitations according to an example embodiment.

FIG. 3X shows an example video image of a surveillance area shown in FIG. 2 from a first vantage point.

FIG. 3Y shows an example video image of the surveillance area shown in FIG. 2 from a second vantage point.

FIG. 3Z shows an example synthetic video image of the surveillance area shown in FIG. 2 from a vantage point that is between the first vantage point and the second vantage point.

FIG. 4 shows examples of a lidar and camera combination.

FIG. 5 is a view similar to FIG. 2 where the objects that are being monitored by video surveillance within the area have moved.

FIG. 6X shows an example video image of the surveillance area shown in FIG. 5 from the first vantage point.

FIG. 6Y shows an example video image of the surveillance area shown in FIG. 5 from the second vantage point.

FIG. 6Z shows an example synthetic video image of the surveillance area shown in FIG. 5 from a vantage point that is between the first vantage point and the second vantage point.

FIG. 7 is a block diagram of a typical computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software, hardware and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A system and method are provided for addressing video surveillance fields of view limitations. In some embodiments, the system and method perform video surveillance of a given area and then geo-locate any obstacles within the area, including measuring their overall size and shape. The system and method further map the size, location and shape of the objects into a database and then identify where there are video surveillance coverage gaps.

The system and method are able create a synthetic video image of the area from multiple vantage points. The objects which have been mapped into a database are used to create the synthetic image. The synthetic image that is created can be from a vantage point that is located anywhere between at least two video surveillance vantage points.

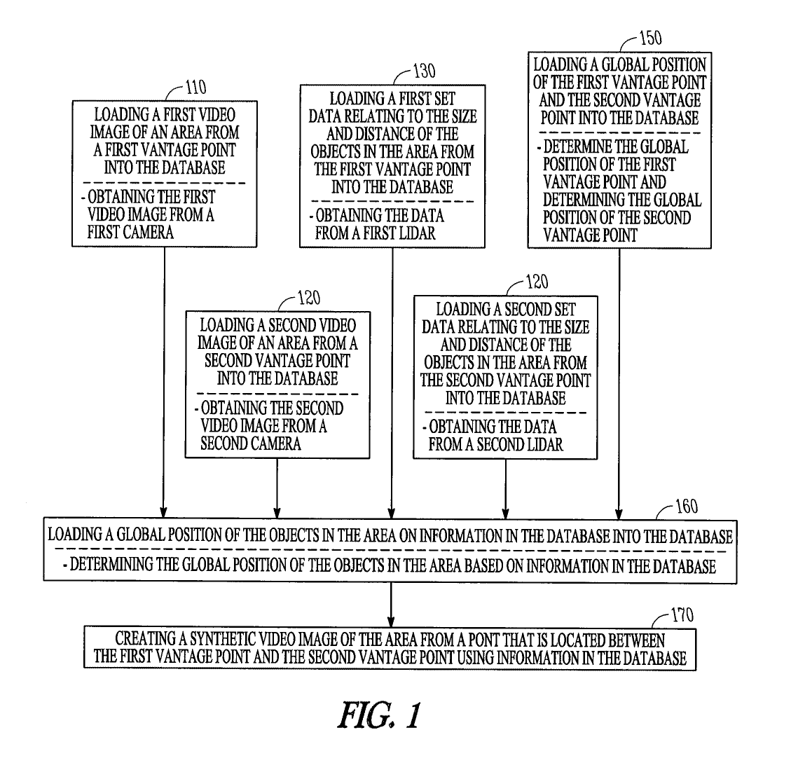

FIG. 1 is a flowchart illustrating a method 100 for addressing video surveillance fields of view limitations according to an example embodiment. The method 100 comprises activity 110 which includes loading a first video image of an area from a first vantage point into a database; activity 120 which includes loading a second video image of the area from a second vantage point into the database; activity 130 which includes loading a first set of data relating to the size and distance of objects in the area from the first vantage point into the database; activity 140 which includes loading a second set data relating to the size and distance of the objects in the area from the second vantage point into the database; activity 150 which includes loading a global position of the first vantage point and the second vantage point into the database; activity 160 which includes loading a global position of the objects in the area based on information in the database into the database; and activity 170 which includes creating a synthetic video image of the area from a point that is located between the first vantage point and the second vantage point using information in the database.

In some example embodiments, activity 150 which includes loading a global position of the first vantage point and the second vantage point into the database may further include determining the global position of the first vantage point and determining the global position of the second vantage point. As an example, determining the global position of the first vantage point may be done simultaneously with determining the global position of the second vantage point by using a global positioning system that includes components which are located at the first vantage point and the second vantage point.

In addition, activity 160 which includes loading a global position of the objects in the area into the database based on information in the database may further include determining the global position of the objects in the area based on information in the database. As an example, the determination may be based on knowing the global positions of the first vantage point and the second vantage point as well as the locations of the objects in the area relative to the first vantage point and the second vantage point.

In some example embodiments, activity 110 which includes loading a first video image of an area from a first vantage point into a database may further include obtaining the first video image from a first camera, and activity 120 which includes loading a second video image of the area from a second vantage point into the database may further include obtaining the second video image from a second camera. As an example, obtaining the first video image from the first camera may be done simultaneously with obtaining the second video image from the second camera.

In some example embodiments, activity 130 which includes loading a first set of data relating to the size and distance of objects in the area from the first vantage point into the database may further include obtaining the data from a first lidar (i.e., Light Detection and Ranging or Laser Imaging Detection and Ranging (system), or Laser Identification Detection and Ranging or Laser Induced Differential Absorption Radar), and activity 140 which includes loading a second set data relating to the size and distance of the objects in the area from the second vantage point into the database may further include obtaining the data from a second lidar. As an example, obtaining the data from the first lidar may be done simultaneously with obtaining the data from the second lidar.

The measurements from the first and second lidar (as well as the global positioning system) may be loaded into the database such that the database contains the geo-location, size and shape of the objects which are within the area. In addition, the location of each surveillance camera and the field of view of each camera may be added to the database such that any areas that are blocked from video surveillance by objects in each camera's field of view may determined by the processor. In preferred embodiments, the fields of view of the lidars are at least equal to the fields of view of the cameras.

The geo-located objects and composite video images of the surveillance zone (which are obtained by the cameras) are used by the processor to generate synthetic video images. Using the information in the database, the processor creates a new vantage point. The objects in the database are tiled with scene data for realistic presentations.

Due to limitations on what is actually in the database, the location of any new vantage points will be limited to a location that is somewhere between any of at least two cameras/lidars. This limitation on the synthetic video image vantage point which may be determined (and subsequently displayed) by the processor is because it is only possible to create a new vantage point for those objects that are tiled with scene data. As an example, a new vantage point could not be created which is on an opposite side of video surveyed objects because there is nothing from that opposite side vantage point that would be visible to the surveillance cameras from the original vantage point(s).

In some example embodiments, obtaining the first video image from a first camera and obtaining the second video image from a second camera may be done simultaneously with obtaining the data from a first lidar and obtaining the data from a second lidar which may also be done simultaneously with receiving a global position of the first vantage point from the global positioning system and receiving the global position of the second vantage point from the global positioning system.

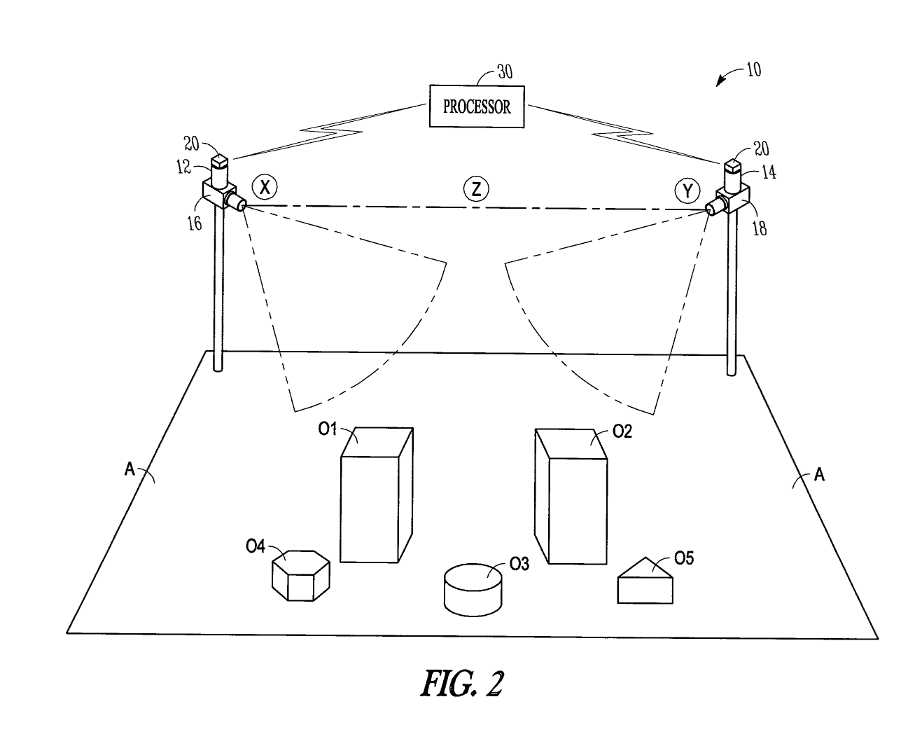

FIG. 2 illustrates a video surveillance system 10 according to an example embodiment. The video surveillance system 10 includes a first video camera 16 that located at a first vantage point X and a second video camera 18 that is located at a second vantage point Y. The video surveillance system 10 further includes a first lidar 12 that is located at the first vantage point X and a second lidar 14 that is located at the second vantage point Y.

The video surveillance system 10 further includes a global positioning system 20 that is used to determine the global position of the first video camera 16, the second video camera 18, the first lidar 12 and the second lidar 14. The video surveillance system 10 further includes a processor 30 that receives data from the first camera 16, the second camera 18, the first lidar 12, the second lidar 14 and the global positioning system 20. The processor 30 creates a synthetic video image from any vantage point (e.g. vantage point Z) that is located between the first vantage point X and the second vantage point Y using the data from the first and second video cameras 16, 18, the first and second lidars 12, 14 and the global positioning system 20.

The global positioning system 20 and the first and second lidars 12, 14 are used to globally locate objects O1, O2, O3, O4, O5 within an area A. The location of the objects O1, O2, O3, O4, O5 within the area A is correlated with video images that are taken from the first and second video cameras 12, 14.

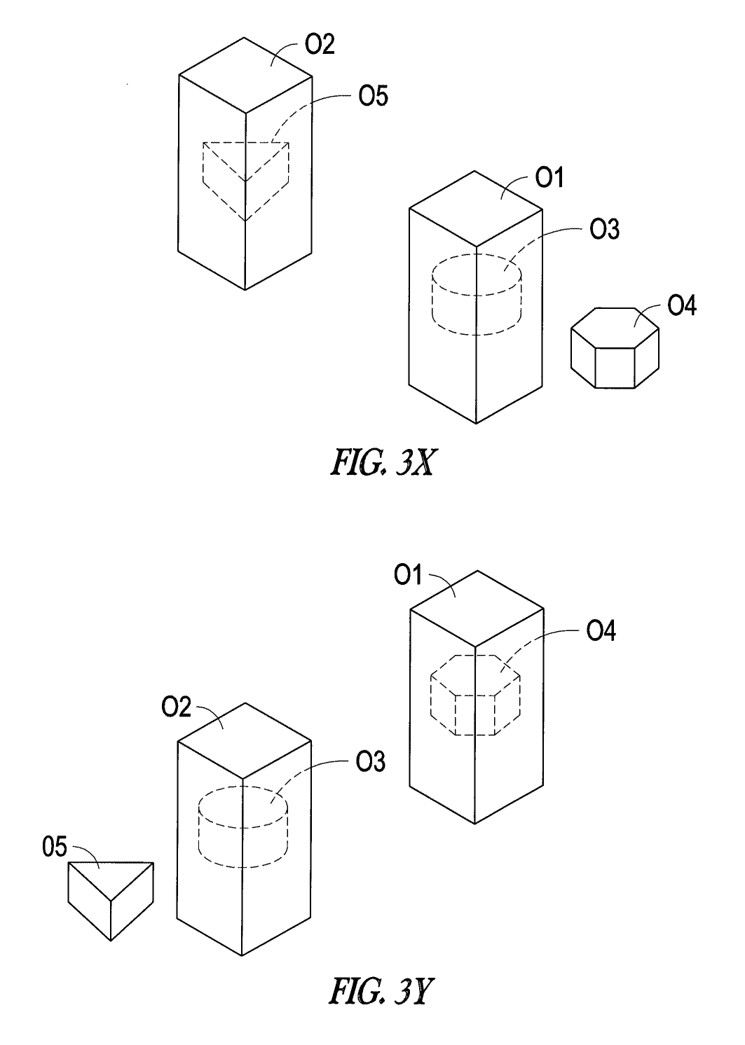

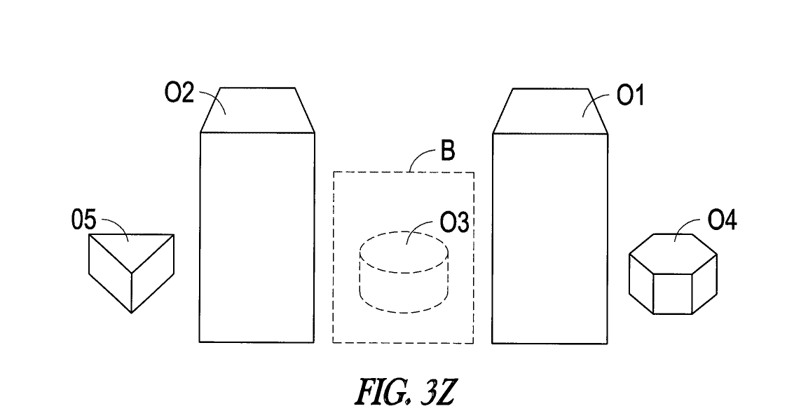

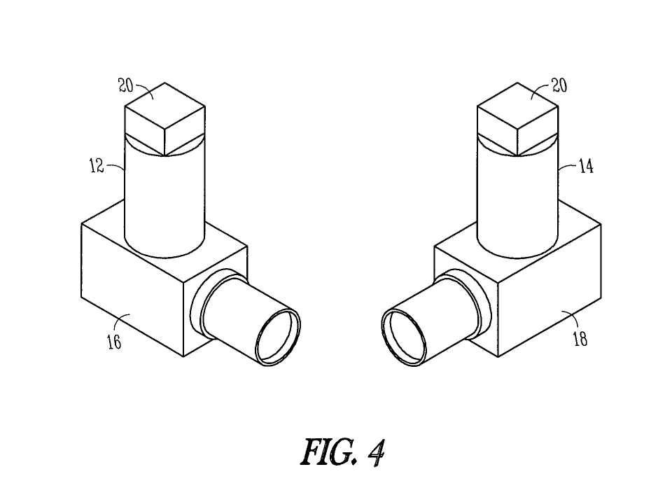

FIG. 3X shows an example view of the area A from vantage point X. Note that objects O1, O2 and O4 are visible from vantage point X while objects O3 and O5 are not visible because object O3 is obstructed by object O1 and object O5 is obstructed by object O2.

FIG. 3Y shows an example view of the area A from vantage point Y. Note that objects O1, O2 and O5 are visible from vantage point Y while objects O3 and O4 are not visible because object O3 is obstructed by object O2 and object O4 is obstructed by object O1.

FIG. 3Z shows an example view of the area A from vantage point Z. Note that objects O1, O2, O4, O5 are visible from vantage point Z and the view from vantage point Z is a synthetic video image that is created by processor 30. It should also be noted that object O3 will not be visible from vantage point Z because object O3 cannot be seen from any existing vantage point (i.e., the first vantage point or the second vantage point). The situation demonstrated in FIGS. 3X, 3Y, 3Z illustrates that additional vantage points may need to be added where object O3 is visible. FIG. 3Z also shows a blank spot B where no information about the scene is available.

FIG. 4 shows examples of a lidar and camera combination. In the example embodiment illustrated in FIGS. 2 and 3, the first lidar 12 is mounted on the first camera 16 and the second lidar 14 is mounted on the second camera 18 such that the global positioning system 20 is mounted to both the first camera 16 and the first lidar 12 and the global positioning system 20 is mounted to both the second camera 18 and the second lidar 14.

When the first and second lidars 12, 14 are mounted on the first and second cameras 16, 18 (or vice versa), the surveillance system 10 is able to continuously update the data to reflect those areas that are blocked from video surveillance by the first and second cameras 16, 18. One example of where this may be useful is for areas such as shipping ports where stacks of shipping containers are constantly moving in and out of a port (i.e., a surveillance area). As the containers stack up or are moved, there will be changing gaps in the video surveillance.

In some example embodiments, the first video camera 16 and the second video camera 18 simultaneously send data to the processor 30 and/or the first lidar 12 and the second lidar 14 simultaneously send data to the processor 30. In addition, the global positioning system 20 may simultaneously send data to the processor 30 along with the first and second lidar 12, 14 and/or the first and second video cameras 16, 18.

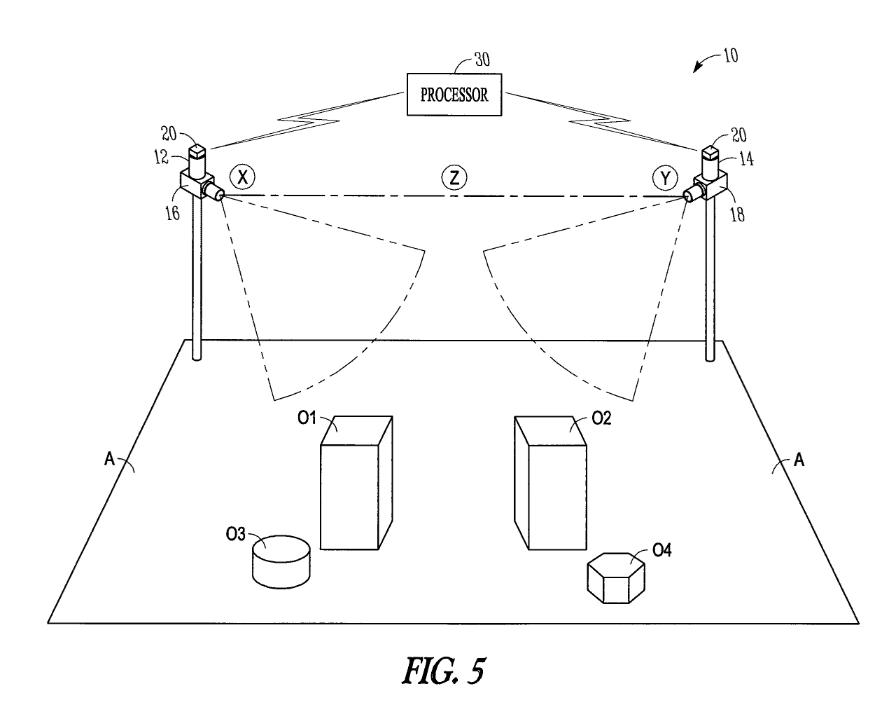

FIG. 5 shows an example where the objects O1, O2, O3, O4 that are being monitored by video surveillance within the area A as shown in FIG. 2 have moved within the area A relative to the first and second lidars 16, 18 and the first and second cameras 12, 14. Note object O5 has been removed from area A and objects O3 and O4 have moved within area A.

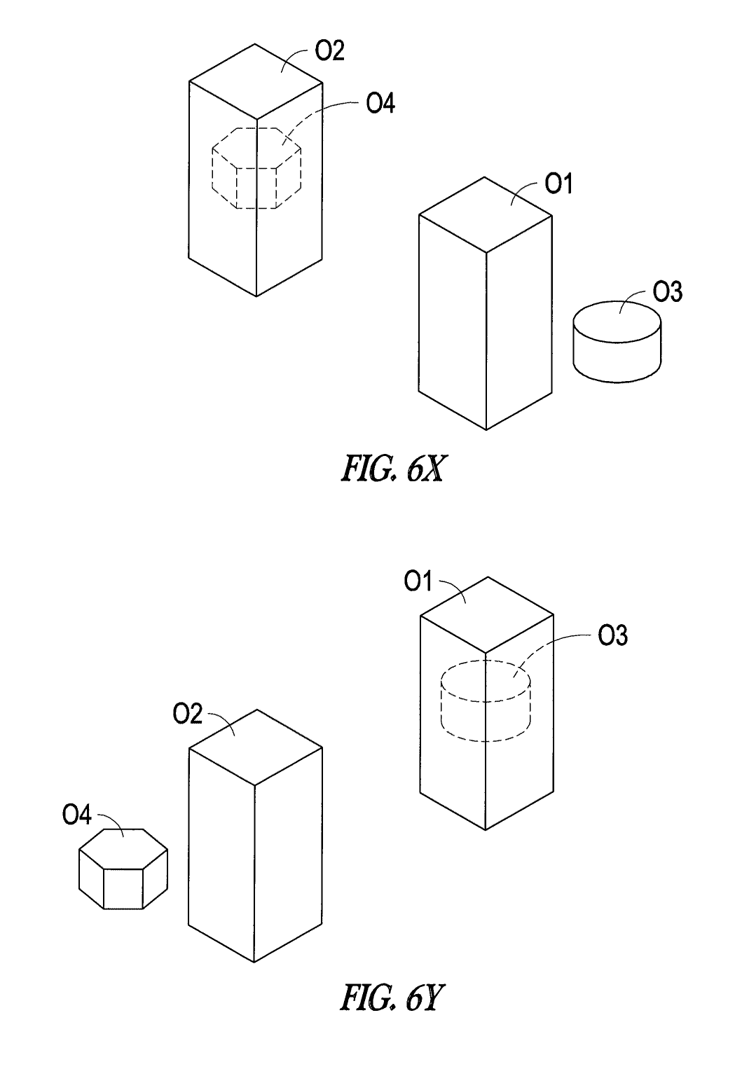

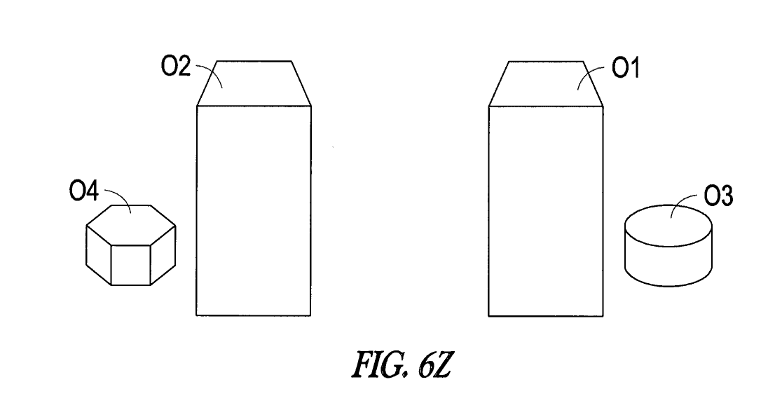

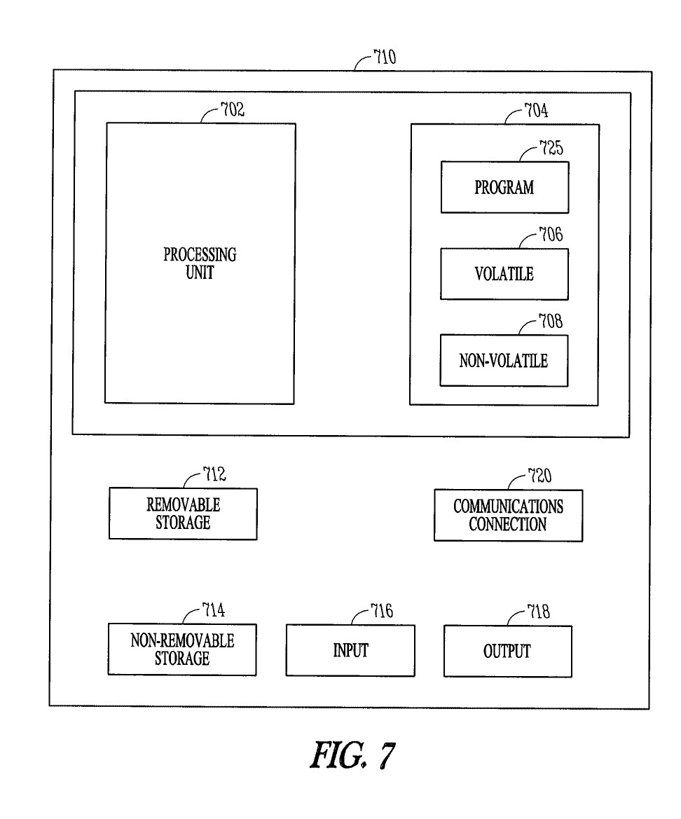

FIGS. 6X and 6Y show example views of the area A and the objects O1, O2, O3, O4 shown in FIG. 5 from vantage points X and Y. FIG. 6Z illustrates an example synthetic video image that may be generated from vantage point Z for the relocated, added and/or removed objects that are within area A and which are shown in FIG. 5.

Although not explicitly shown in the FIGS., the first and second lidars 12, 14 and the first and second cameras 16, 18 are able to monitor when a portion of any of the objects may be moved within or removed from area A. As an example, the system 10 is able to monitor when one or more containers in a stack of containers is removed from (or added to) the rest of the stack of containers.

It should be noted that embodiments are contemplated where only a single lidar and/or camera are used to supply data to the processor 30 relating to the size and distance of objects in an area A from the first vantage point X and then subsequently supply data relating to the size and distance of objects in the area from the second vantage point Y. In addition, a single component in the global positioning system 20 may be used to supply the global position of the first and second vantage points X, Y to the processor 30.

Embodiments are also contemplated where multiple lidars and/or cameras are used to supply data to the processor 30 relating to the size and distance of objects in an area from multiple vantage points. In addition, multiple components in the global positioning system 20 may be used to supply the global positions of the multiple vantage points to the processor 30.

In some embodiments, a computer system may form part of the system 10. A block diagram of an example computer system that executes programming for performing some of the methods described above is shown in FIG. 7. A general computing device in the form of a computer 710, includes a processing unit 702 (e.g., processor 30), memory 704, removable storage 712, and non-removable storage 714. Memory 704 may include volatile memory 706 and non-volatile memory 708. Computer 710 may include—or have access to a computing environment that includes—a variety of computer-readable media, such as volatile memory 706 and non-volatile memory 708, removable storage 712 and non-removable storage 714. It should be noted that the databases referred to above for crating the synthetic image may be part of any of the processing unit 702 (e.g., processor 30), memory 704, volatile memory 706, non-volatile memory 708, removable storage 712, and non-removable storage 714.

Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions, as well as data, including video frames.

Computer 710 may include or have access to a computing environment that includes input 716, output 718, and a communication connection 720. In some example embodiments, the input 716 may allow a user to select the vantage point (e.g., vantage point Z) of the synthetic video image. In addition, the output 718 may include a display that illustrates the synthetic video image generated by the processor 30.

The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium, such as storage devices, are executable by the processing unit 702 of the computer 710. A hard drive, CD-ROM, and RAM are some examples of articles including a computer-readable medium.

The Abstract of the Disclosure is provided to comply with 37 C.F.R. §1.72(b) with the understanding that it will not be used to interpret or limit the scope or meaning of the claims. The above description and figures illustrate embodiments of the invention to enable those skilled in the art to practice the embodiments of the invention. Thus the following claims are hereby incorporated into the Detailed Description, with each claim standing on its own as a separate embodiment.

1. A method of addressing video surveillance fields of view limitations, the method comprising:
loading a first video image of an area from a first vantage point into a database;
loading a second video image of the area from a second vantage point into the database;
loading a first set of data relating to the size and distance of objects in the area from the first vantage point into the database;
loading a second set data relating to the size and distance of the objects in the area from the second vantage point into the database;
loading a global position of the first vantage point and the second vantage point into the database; and
loading a global position of the objects in the area based on information in the database into the database; and
creating a synthetic video image of the area from a point that is located between the first vantage point and the second vantage point using information in the database.

2. The method of claim 1 wherein loading a global position of the first vantage point and the second vantage point into the database includes determining the global position of the first vantage point and determining the global position of the second vantage point.

3. The method of claim 2 wherein loading a global position of the objects in the area based on information in the database into the database includes determining the global position of the objects in the area based on information in the database.

4. The method of claim 2 wherein determining the global position of the first vantage point is done simultaneously with determining the global position of the second vantage point.

5. The method of claim 1 wherein loading a first video image of an area from a first vantage point into a database includes obtaining the first video image from a first camera, and loading a second video image of the area from a second vantage point into the database includes obtaining the second video image from a second camera.

6. The method of claim 5 wherein obtaining the first video image from the first camera is done simultaneously with obtaining the second video image from the second camera.

7. The method of claim 1 wherein loading a first set of data relating to the size and distance of objects in the area from the first vantage point into the database includes obtaining the first set of data from a first lidar, and loading a second set data relating to the size and distance of the objects in the area from the second vantage point into the database includes obtaining the second set of data from a second lidar.

8. The method of claim 7 wherein obtaining the first set of data from the first lidar is done simultaneously with obtaining the second set of data from the second lidar.

9. The method of claim 1 wherein loading a global position of the first vantage point and the second vantage point into the database includes determining the global position of the first vantage point and determining the global position of the second vantage point, and wherein loading a first video image of an area from a first vantage point into a database includes obtaining the first video image from a first camera, and loading a second video image of the area from a second vantage point into the database includes obtaining the second video image from a second camera, and wherein loading a first set of data relating to the size and distance of objects in the area from the first vantage point into the database includes obtaining the first set of data from a first lidar, and loading a second set data relating to the size and distance of the objects in the area from the second vantage point into the database includes obtaining the second set of data from a second lidar, and wherein determining the global position of the first vantage point includes receiving the global position of the first vantage point from a global positioning system that is located on the first lidar or the first camera and determining the global position of the second vantage point includes receiving the global position of the second vantage point from the global positioning system that is located on the second lidar or the second camera.

10. The method of claim 9 wherein obtaining the first video image from the first camera and obtaining the second video image from the second camera is done simultaneously with obtaining the first set of data from the first lidar and obtaining the second set of data from the second lidar which is also done simultaneously with receiving the global position of the first vantage point from the global positioning system and receiving the global position of the second vantage point from the global positioning system.

11. A video surveillance system comprising:
a first video camera located at a first vantage point;
a second video camera located at a second vantage point;
a first lidar located at the first vantage point;
a second lidar located at the second vantage point;
a global positioning system that detects the location of the first video camera, the second video camera, the first lidar and the second lidar; and
a processor that receives data from the first camera, the second camera, the first lidar, the second lidar and the global positioning system and creates a synthetic video image from a viewpoint that is located between the first vantage point and the second vantage point using the data.

12. The video surveillance system of claim 11 wherein the first camera is mounted on the first lidar and the second camera is mounted on the second lidar.

13. The video surveillance system of claim 11 further comprising a display that illustrates the synthetic video image generated by the processor.

14. The video surveillance system of claim 11 further comprising an input that allows a user to select the viewpoint of the synthetic video image.

15. The video surveillance system of claim 11 wherein the first video camera and the second video camera simultaneously send data to the processor.

16. The video surveillance system of claim 11 wherein the first lidar and the second lidar simultaneously send data to the processor.

17. The video surveillance system of claim 11 wherein the first lidar, the second lidar, the first video camera, the second video camera and the global positioning system simultaneously send data to the processor.

18. A video surveillance system comprising:
a first video camera located at a first vantage point;
a second video camera located at a second vantage point;
a first lidar located at the first vantage point;
a second lidar located at the second vantage point;
a global positioning system for detecting the location of the first video camera, the second video camera, the first lidar and the second lidar; and
a processor to receive data from the first camera, the second camera, the first lidar, the second lidar and the global positioning system to create a synthetic video image from a viewpoint that is located between the first vantage point and the second vantage point using the received data.

19. The video surveillance system of claim 18 wherein the first camera is mounted on the first lidar and the second camera is mounted on the second lidar, and wherein the first video camera and the second video camera each send data to the processor as the data is collected.

20. The video surveillance system of claim 19 further comprising:
a display to illustrate the synthetic video image generated by the processor; and
an input to facilitate selection of the viewpoint of the synthetic video image.
